(19) United States
(12) Patent Application Publication
(10) Pub. No.: US 2008/0307450 A1
(43) Pub. Date: Dec. 11, 2008

(54) Information Carrier, a Device for Recording and/or Reproducing Information, as Well as a Method for Manufacturing an Information Carrier

(75) Inventors: Josephus Arnoldus Hendricus Maria Kahlman, Eindhoven (NL); Waltherus Cornelis Jozef Bierhoff, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,818

(22) PCT Filed: Apr. 7, 2005
(86) PCT No.: PCT/IB05/51143

§ 371 Date: Oct. 11, 2006

(30) Foreign Application Priority Data
Apr. 14, 2004 (EP) 04101522.3

(51) Int. Cl. G11B 7/24; G11B 7/26

(52) U.S. Cl. 720/723; 369/14; 369/273; 264/2.7; G9B/7.139

(57) ABSTRACT

Information carrier, comprising a disc (101) which is provided with at least one data layer (102) for optically reading and/or writing information, wherein the disc comprises an annular clamping part (C), to be held by a clamper (121) during use, wherein the disc comprises at least one integrated circuit (103), wherein said integrated circuit comprises a first communicator (104) for communication with at least a second, external, communicator (111) during use, wherein the first communicator extends in a centre area (T) which is enclosed by said annular clamping part.

The invention relates to an information carrier, comprising a disc which is provided with at least one data layer for optically reading and/or writing information, wherein the disc comprises an annular clamping part, to be held by a damper during use, wherein the disc comprises at least one integrated circuit, wherein said integrated circuit comprises a first communicator for communication with at least a second, external, communicator during use.

Such an information carrier is known from the U.S. Pat. No. 6,044,046. The known information carrier is a compact disk (CD), including a circular disc having a centre hole. The circular disc is provided with an information-carrying layer. The CD is provided with an annular module, comprising a chip and a CD coupling element. The CD coupling element may be an integral part of the chip. The chip may provide various functions. For instance, the chip may be used as a security element. Particularly, the chip may contain a decryption key which is necessary for decrypting information, which information has been stored in the information-carrying layer of the CD. An other appliance of the chip is an accounting medium, which permits only a limited number of executions or accesses with respect to programs or information stored on the CD. Also, the chip may be used for storing personal settings, calculation results, game scores and the like. In another application, the CD-chip may perform calculations for different purposes. Such chip-in-disc may provide a nearly unhackable disc copy protection system in existing or new disc standards.

During use, the known CD is clamped in a CD-drive between two pressure plates. The pressure plates hold onto the annular clamping part of the CD, said annular clamping part enclosing said centre hole of the disc. The known CD-drive is provided with drive coupling elements consisting of coils, for communication with the coupling elements of the CD, such that information can be exchanged between the CD-drive and the CD-chip during rotation of the CD about the centre thereof.

A problem of known information carriers which comprise chips and communication means, is, that the relative contact time during disc rotation between the coupling elements of the CD on the one hand and the CD-drive on the other (also called ‘duty cycle’) is relatively low, or at least less that 100%. Therefore, only a small data flow and power flow can be achieved between the disc chip and the CD-drive. In said U.S. Pat. No. 6,044,046 it is proposed, to use a discrete CD coupling element in the form of a circular disc for permitting continuous data transfer without interruption. However, this makes the manufacturing of the CD relatively complicated, leading to an expensive CD. A further problem of the known information carrier is, that a relatively low efficiency of energy transfer from and/or to the information carrier can be achieved during use.

The present invention aims to improve the information carrier. More particularly, the invention aims to provide a relatively inexpensive information carrier comprising an integrated circuit, wherein the duty-cycle between the integrated circuit and an exterior communicator can be relatively high.

According to the present invention, this object is achieved by the information carrier as defined in claim 1, which carrier comprises a disc which is provided with at least one data layer for optically reading and/or writing information, wherein the disc comprises an annular clamping part, to be held by a damper during use, wherein the disc comprises at least one integrated circuit, wherein said integrated circuit comprises a first communicator for communication with at least a second, external, communicator during use, wherein the first communicator extends in a centre area which is enclosed by said annular clamping part.

According to the invention, the first communicator extends in a centre area which is enclosed by said annular clamping part.

Consequently, the first communicator extends relatively close to the centre of the disc, so that a relatively high duty-cycle can be achieved during used. Furthermore, since the first communicator extends at least in the centre of the disc, a relatively high efficiency of energy transfer between the first and second communicator can be reached during use. For instance, said centre area may comprise an annular transition part of the disc, for example the annular transition part which encloses the centre hole of the disc, viewed in a radial disc direction.

The present invention further relates to an information carrier, comprising a disc which is provided with at least one layer for optically reading and/or writing information, wherein the disc comprises at least one integrated circuit, wherein said integrated circuit comprises a first communicator for communication with at least a second, external, communicator during use.

Following from the foregoing, such an information carrier is known from the said U.S. Pat. No. 6,044,046 and has the already mentioned problems.

The present invention aims to improve this information carrier. More particularly, the invention aims to provide a relatively inexpensive information carrier comprising an integrated circuit, wherein the duty-cycle between the integrated circuit and an exterior communicator can be 100%.

To this aim, according to the present invention, the first communicator advantageously extends at least in the central point of the disc.

This also provides at least the above-mentioned advantages concerning the subject-matter of claim 1. Particularly, in this way, a 100% duty-cycle can be achieved, as well as a relatively high efficiency of energy transfer between the first and second communicator can be reached during use.

It is to be noted, that both claim 1 and claim 2 relate to the same inventive concept, namely an information carrier, wherein said first communicator extends at least in a central area of the disc. In both cases, the first communicator at least extends near the centre of the disc, thus providing the possibility of achieving relatively high duty-cycles. Thus, in both embodiments, a large signal-coupling between a first and second communicator can be achieved, allowing for a high data-transfer between the respective information carrier on the one hand and disc reading and/or writing device on the other hand.

According to a preferred embodiment of the invention, said first communicator is part of said integrated circuit.

Therefore, the information carrier does not comprise discrete communicators such as antenna parts which extend over a relatively large distance outside the integrated circuit. Consequently, the first communicator may be relatively compact, small, cheap and light-weight. Besides, in this way, the manufacturing of the information carrier is relatively uncomplicated, upholding small disc tolerances which may have to be met, so that the information carrier may also be produced relatively cheap. Particularly, an integrated circuit assembly, comprising the communicator and the integrated circuit, can be provided much more easily in a small form factor information carrier, compared to bonded chips having discrete antennas, external wiring and the like. In contrast, known chip-in-disc arrangements, comprising bonded chips, discrete antennas, and/or separate batteries are relatively expensive, bulky and difficult to manufacture. The integrated circuit, containing the first communicator, may be, for instance, a so called ‘unbonded chip’. Such an unbonded chip is not connected mechanically to external circuitry, external antennas and the like.

According to one aspect of the invention, there is provided a device for recording and/or reproducing information on/from at least one data layer of a rotatable disc, wherein the device comprises at least a second communicator for communicating with at least a first communicator of a disc according to any of claims 1-12.

Using this device in combination with a disc according to the present invention leads to relatively high duty cycles and high energy transfer efficiency. Particularly, the second communicator can achieve a high duty-cycle with relative ease, preferably a nearly or substantially 100% duty-cycle, when cooperating with the first communicator during disc rotation. To that aim, the second communicator of said recording and/or reproducing device can simply be arranged for communication with a first communicator of an information carrier, which first communicator extends in said central disc area being enclosed by the clamping area, and/or extends at least in the central disc point. Besides, the device according to the present invention may be made relatively compact.

The present invention further provided a method for manufacturing an information carrier, which method is characterized by the features of claim 26.

According to the invention, a disc is injection-moulded such, that the disc comprises no central aperture. The central part of the disc is provided with at least one integrated circuit, wherein said integrated circuit comprises a first communicator for communication with at least a second, external, communicator during use.

In this way, an information carrier according to at least claim 1 can be manufactured relatively fast, accurately and easily, providing the above-mentioned advantages. Preferably, the integrated circuit and the first communicator are provided in one part, for instance an unbonded chip or the like. However, in the present manufacturing method, said first communicator may also be a separate part with respect to the integrated circuit.

Alternatively, according to claim 27, a disc is injection-moulded such, that the disc comprises a central aperture, wherein a bridge part is applied to the disc for bridging at least part of the central aperture, wherein the bridge part is being provided with at least one integrated circuit, wherein said integrated circuit comprises a first communicator for communication with at least a second, external, communicator during use.

In that case, the disc can be manufactured, for instance, using standard disc manufacturing techniques, after which the central aperture is at least partly bridged with the bridge part for holding or receiving the integrated circuit and the first communicator.

Further advantageous embodiments of the invention are described in the dependent claims.

The invention will now be described in more detail on the basis of exemplary embodiments shown in the accompanying drawing.

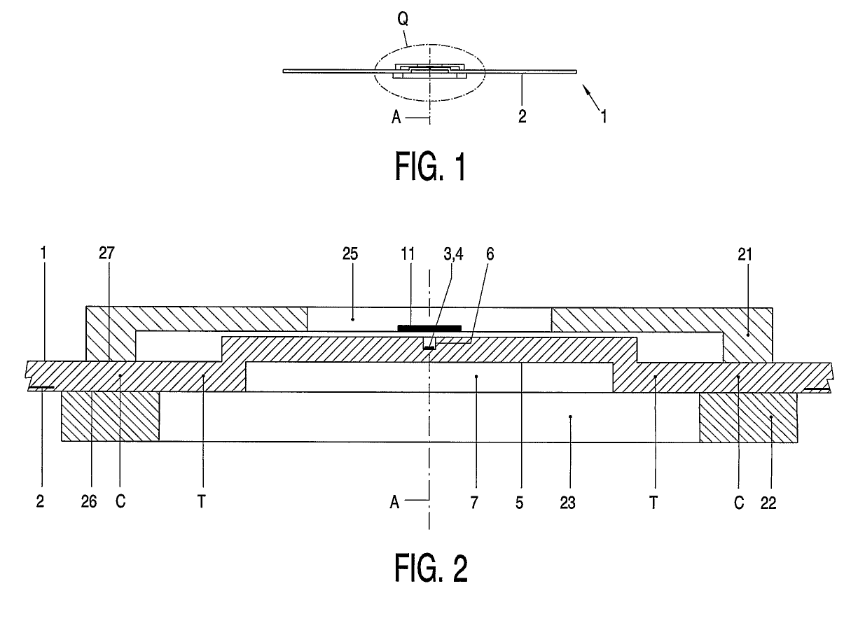

FIG. 1 is a schematic cross section of the a first embodiment of the invention;

FIG. 2 is a detail Q of FIG. 1;

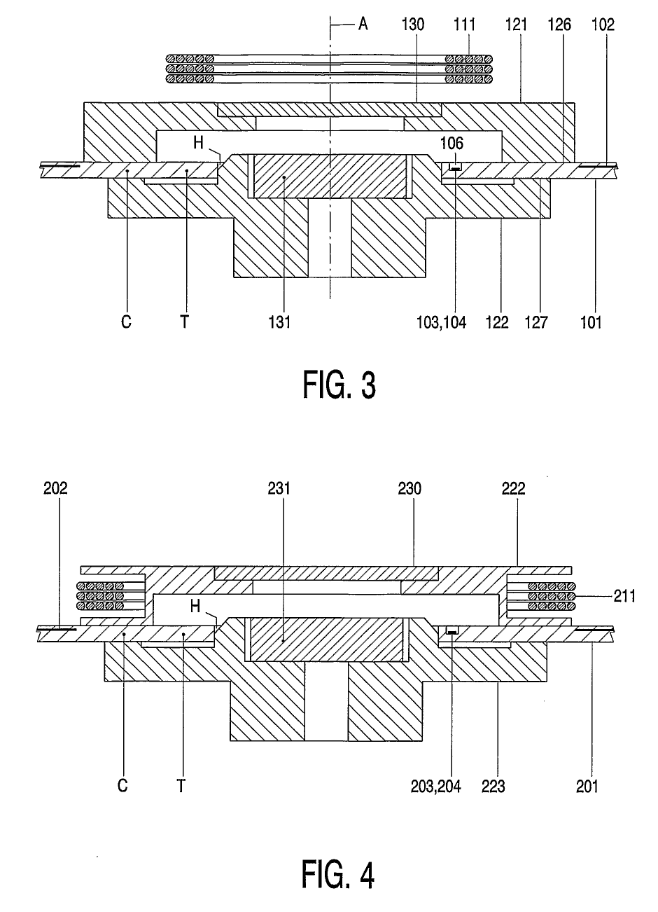

FIG. 3 is a similar detail as FIG. 2 of a second embodiment;

FIG. 4 is a similar detail as FIG. 2 of a third embodiment;

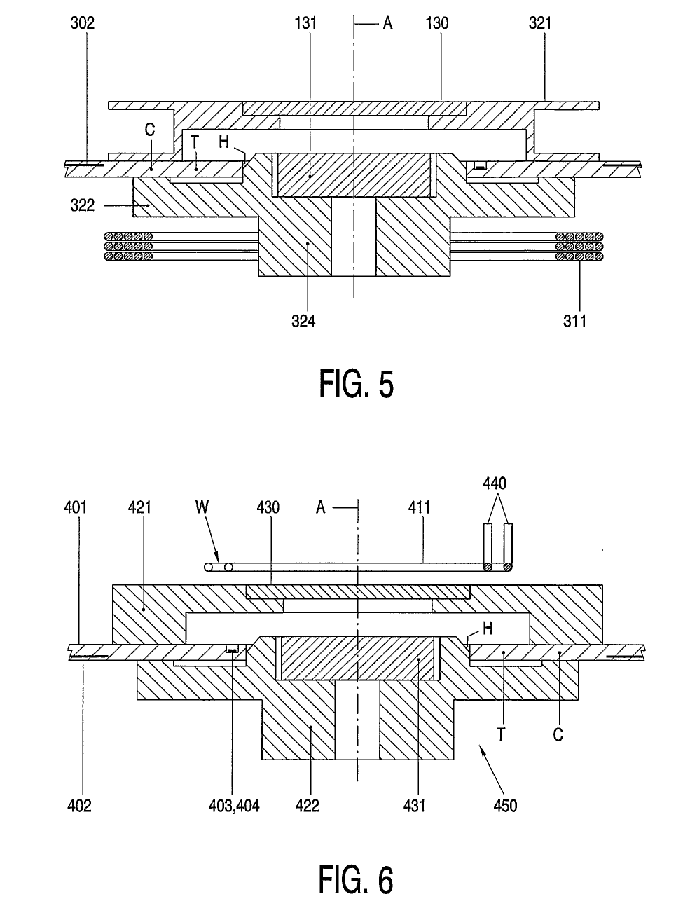

FIG. 5 is a similar detail as FIG. 2 of a fourth embodiment;

FIG. 6 is a similar detail as FIG. 2 of a fifth embodiment;

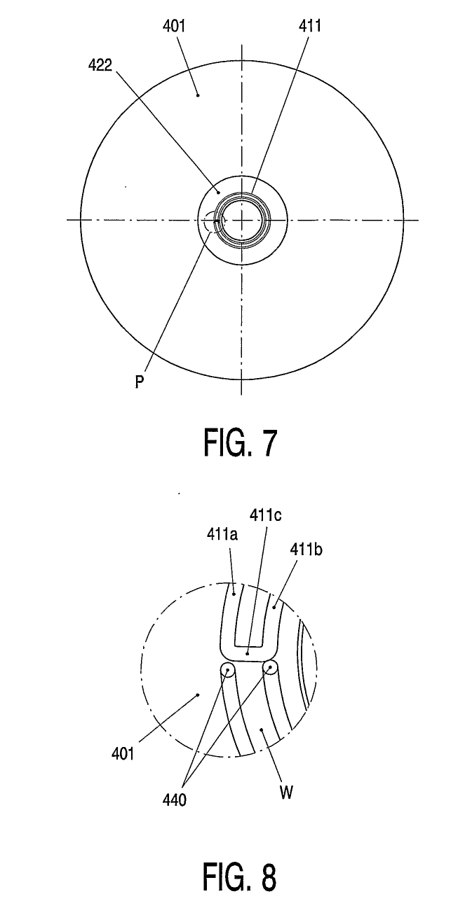

FIG. 7 is a top view of the fifth embodiment shown in FIG. 6;

FIG. 8 is a detail P of FIG. 7;

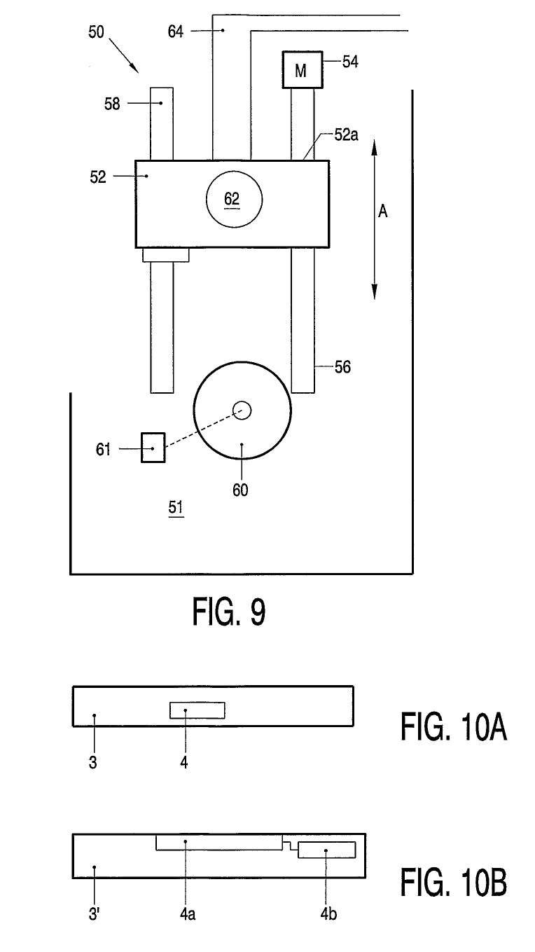

FIG. 9 schematically shows an embodiment of a device for recording and/or reproducing information; and

FIGS. 10A, 10B schematically show embodiments of an unbonded chip.

In the present application, equal or similar parts have equal or similar reference signs.

FIGS. 1 and 2 schematically show an information carrier, as well as a clamper 21 and part of a turntable 22 of a device 50 for recording and/or reproducing information on/from at least one data layer of a rotatable disc. Such a device 50 is schematically shown in FIG. 9.

The information carrier comprises a substantially circular disc 1 which is provided with at least one layer 2 for optically reading and/or writing a first type of data, for instance video and/or audio information, computer data and/or the like. The disc 1 is arranged to be rotated about a virtual rotation axis A during use for reading and/or writing said first type of data. Said rotation axis A extends through the centre point of the disc 1.

The disc 1 comprises an annular clamping part C which surrounds an annular transition part T of the disc, when viewed in a radial disc direction. The at least one data layer 2 extends outside the annular clamping part C of the disc 1. Both the annular clamping part C and annular transition part T are concentric with respect to the disc central point.

The central area of the disc is not provided with a through-hole, but with an integral, circular central bridge part 5 which is surrounded by said disc transition part T, viewed in the radial disc direction. In the present embodiment, this bridge part 5 forms a central protrusion of the disc 1, such that a concave side of the bridge part 5 abuts a central space 7 for a turntable or the like.

The damper 21 and turntable part 22 are arranged to hold the disc 1 by the annular clamping part C of the disc 1, for instance using magnetic force of the like. Particularly, one or both of the damper 21 and turntable part 22 may comprise magnets and suitable metal parts for providing sufficient clamping forces when the disc 1 is located there-between. In the present embodiment, both the damper 21 as well as the turntable part 22 comprise a central aperture 23, 25. The damper 21 and turntable part 22 provide two opposite clamping surfaces 26, 27 which are also annular, for holding the annular clamping part C of a disc 1 there between.

A first side of the central area of the disc 1 is provided with a small central blind hole 6. The surface area of the bottom of the hole 6 may be, for instance about 1 mm² or less, particularly for instance about 0.5 mm² or less. This hole 6 extends in the side of the bridge part 5, which side is turned away from said central space 7. On the bottom of the blind hole 6, an integrated circuit 3 is provided. The circuit 3 is fixed to the disc 1, for instance by adhesive, by one or more fixation members, by at least partial encapsulation, by using suitable fixing means and/or the like.

The integrated circuit 3 integrally comprises a first communicator 4 for communication with at least a second, external, communicator 11 during use, for exchanging a second type of data. This second type of data may be, for instance, copyright information, disc unlocking keys, computer code and/or the like. The first communicator 4 is located at least in the central point of the disc 1, on the rotation axis A. Therefore, the first communicator 4 extends in the disc part 5, 6 which is enclosed by the annular clamping part C, viewed in a radial disc direction.

The integrated circuit 3 may be, for instance, an unbonded-chip. Such a chip does not have an external antenna. In that case, said first communicator 4 is part of said integrated circuit 3. The integrated circuit 3 preferably has small dimensions, for instance covering an area of only about 0.4 mm² and/or having a thickness in the range of about 50-100 microns, for example a thickness of about 60 microns. For instance, the integrated circuit 3 may be the RF/RF coupled MEU chip of Hitachi. An embodiment of such a chip 3 is schematically shown in FIG. 10A, and comprises a RF-communicator 4. In that case, the first communicator may comprise at least an antenna 4 for receiving and/or transmitting radio frequency signals. An other embodiment of a suitable chip 3′ is schematically shown in FIG. 10B. This alternative chip is an optical/RF coupled chip 3′, comprising at least an optical light transmitter and/or receiver, for instance a photo diode 4a, for transmitting and/or receiving power and data. Such an optical/RF coupled chip further may comprise, for instance, an on-chip transmitter 4b for transmitting data.

Said second communicator 11 of the device 50, as shown in FIG. 9, can be arranged in various ways, depending amongst others on the arrangement of said first communicator 4 to be communicated with. For instance, the second communicator 11 may be arranged for optical, inductive and/or electromagnetic communication or the like. In the present embodiment, said second communicator 11 is arranged to send and/or transmit data, preferably substantially, to the central point of a disc 1 during rotation thereof.

In the embodiment of FIGS. 1 and 2, the second communicator comprises a relatively compact coil 11 which is located near the centre of the disc 1 when the disc is being held by the damper 21 and turntable part 22. The second communicator 11 may be attached to the clamper 21, the turntable part 22, or to an other suitable part of the respective recording and/or reproducing device. Besides, the second communicator 11 may be located at least partly outside or within said damper 21 or turntable part 22. In the present embodiment, said second communicator 11 is located within the central damper aperture 25 which extends opposite the first communicator 4 during use. The second communicator 11 is positioned concentrically with respect to the disc rotation axis A, opposite the first communicator 4, when the disc 1 is being held by the damper 21 and turntable part 22. A motorized mechanism may be provided for positioning and/or moving the coil 11 towards the position shown in FIG. 2. On the other hand, the second communicator 11 may, for instance, be in fixed position of the respective device 50.

During operation, the disc 1 can be rotated about the rotation axis A, by said turntable 22 of the disc reading and/or writing device 50. During the rotation, the first communicator 4 remains in the central position, on the rotation axis A, as shown in FIG. 2. Information can be exchanged between the first communicator 4 and the second communicator 11 during the rotation of the disc 1. Because of the arrangement of the communicators 4, 11 with respect to each other, a high communication contact time can be achieved, particularly of about 100%, as well as a high efficiency of energy transfer between the communicators 4, 11. Therefore, data can be exchanged between the communicators 4, 11 relatively fast and/or reliable, as well as efficiently, with a relatively low power consumption. Besides, such communication can also be carried out when the disc is not rotated. In that case, preferably, communication is always possible, independent of the rotation position of the disc 1 with respect to the disc playing device 50. Then, the second communicator 11 can exchange data with the first communicator relatively fast after the disc has been loaded in the device 50, without the disc 1 having to be rotated for that purpose.

The information carrier of the first embodiment can be manufactured in various ways. For instance, the information carrier may be manufactured by injection-moulding , wherein a disc 1 is being injection-moulded such, that the disc 1 comprises no central aperture, wherein the central part of the disc 1 is provided with the integrated circuit 3 and the first communicator 4. The integrated circuit 3 and communicator 4 may be, for instance, simply be joined with the disc 1 during the injection-moulding process, or thereafter.

According to an alternative method, the disc 1 is being injection-moulded such, that the disc does comprise a central aperture, wherein a bridge part 5 is applied to the disc for bridging at least part of the central aperture. In that case, the bridge part 5 may already be provided with the first communicator 4 before the bridge part 5 is applied to the disc 1, or the bridge part 5 may be provided with the first communicator during or after being joined with the disc 1. The bridge part 5 may be attached to the disc 1 in various ways, using glue, a melting process and/or other suitable means or methods

FIG. 3 depicts a second embodiment of the present invention. In the second embodiment, the information carrier comprises a disc 101, comprising at least one data layer 102, as well as a central hole H. The data layer 112 is suitable for optically reading and/or writing information, particularly a first type of data. The disc also comprises an annular clamping part C, to be held between annular surfaces of a damper 121 and a turntable 122 during use, as has been shown in FIG. 3. The data layer 102 extends in the disc area located outside the clamping part C of the disc, viewed in a radial direction. A first side of the present disc 101 further comprises a blind hole 106, containing an integrated circuit 103 and a first communicator 104, for instance a circuit which is similar to the above-described integrated circuit of the first embodiment. In the present embodiment, the integrated circuit 103 and the first communicator 104 are located in the annular transition disc part T which is enclosed by said clamping part C. Therefore, the first communicator is relatively close to the central disc aperture H.

FIG. 3 further shows part of a device for recording and/or reproducing information on/from at least one data layer of the disc 101. The device comprises a damper 121 and a turntable 122, wherein the damper 121 comprises a central metal plate 130. The turntable 122 is provided with a magnet 131 for attracting the damper 121 via the metal plate 130. Besides, the device comprises a second communicator, particularly a coil 111, which is located outside the clamper/turntable arrangement. The second communicator 111 is arranged concentrically with respect to the axis of rotation A of the disc 101. The inner and outer diameters of the coil 104 are smaller than the inner diameter of the annular clamping part C of said disc 101, leading to a compact coil design. In the present embodiment, the second communicator 111 is positioned such, that the second communicator 111 is arranged opposite the first side of the disc 101 during use.

Since the first communicator 104 of the second embodiment extends near the disc centre, in and/or on said transition part T, a relatively high duty-cycle can be achieved during use, concerning communication between the first and second communicator 104, 111. Besides, since the first communicator 104 is positioned near the centre hole H of the disc, the second communicator 111 can be relatively compact, so that an efficient transfer of energy between the communicators 104, 111 can be reached.

An alternative embodiment of the device of FIG. 3 is shown in FIG. 4. Therein, the second communicator, being the coil 211, extends in an annular, circumferential groove of the damper 221. This provide the further advantage of a relatively compact arrangement, viewed in axial direction along the rotation axis A.

Yet another alternative embodiment of the device is shown in FIG. 5. According to this alternative embodiment, the coil 311 is positioned such, that the coil 311 is arranged opposite a second side of the disc 302 during use, which second disc side is faced away from said first disc side. Particularly, in this case, the coil 311 extends around a turning shaft 324 of the turntable 322. Such an arrangement is relatively robust, particularly since the coil 311 remains in the same position below the turntable when a disc is loaded/unloaded.

The embodiment shown in FIGS. 6-8 differs from the embodiments of FIGS. 3-5, in that the device 450 for recording and/or reproducing information is provided with a dipole antenna 411 serving as the second communicator. The dipole antenna 411 is arranged and dimensioned such, that the antenna can generate an electromagnetic field which is concentrated in the path of the first communicator 404 of the disc 401, being held by the damper 421 and turntable 422 of the device 450, during use. To this aim, the present dipole antenna 411 is substantially circular, comprising two concentric, substantially circular antenna arms 411a, 411b, which delimit a substantially annular dipole antenna area W, when viewed in the axial direction along the disc rotation axis A. First ends of the antenna arms 411a, 411b are connected to one another by an interconnecting antenna part 411c. Opposite second ends of the antenna arms 411a, 411b are provided with connection legs 440 which—in the present embodiment—extend substantially perpendicularly with respect to the antenna arms 411a, 411b. During use, signals are fed from/to the dipole antenna via these collection legs 440. As clearly follows from FIG. 8, the first and second ends of the antenna arms 411a, 411b lie close to each other, so that the antenna arms form almost closed circular loops. The path of the first communicator 404 overlaps substantially with the annular area W which is enclosed by the two dipole antenna arms 411a, 411b. In other words: the radius of the path of the first communicator 404 is larger than the radius of the inner antenna arm 411b, and smaller than the radius of the outer antenna arm 411a. Because of this arrangement, the electromagnetic field of the second communicator 411 is concentrated in the path where the first communicator moves in during use. Therefore, a high coupling factor between the antenna 411 of the device 450 and each first communicator of a disc 1 can be achieved in a simple manner. Besides, a high efficiency of energy transfer between the first and second communicator can be achieved in this way.

The device 50 schematically shown in FIG. 9, is a device for recording and/or reproducing information on/from at least one data layer of a rotatable disc, particularly a disk player. The device has a frame 51 and comprises an optical pickup head 52, as well as a turntable 60 for rotating a disc (not shown) about a rotation axis. The turntable 60 may, for instance, comprise a damper for holding a disc by an annular clamping part thereof, for instance the damper 21, 121, 221, 321, 421 as shown in FIGS. 1-8, for holding the disc 1.

The optical pickup head 52 can be moved along a direction indicated by the double arrow head A hereafter also called the traverse direction. To this aim, the device 50 is provided with a guide shaft 58 and a motor 54 for rotating a lead screw 56, the lead screw 56 being arranged to cooperate with an engagement portion 52a of the pickup head 52. The pickup head comprises a lens 62 for directing a light beam 64 onto a data layer of a disc, which is located on the turntable 60 during use.

The present device 50 is provided with a clamping and/or turntable arrangement as shown in any of FIGS. 1-8. Therefore, as is schematically depicted, the device 50 is provided with a second communicator 61 which is arranged to communicate with a first communicator of a disc being positioned on the turntable 60. Consequently, the device 50 can provide relatively high coupling factors with communicators of information carrying discs during use. Furthermore, the device 50 can be made relatively compact, having a relatively compact second communicator 61. Besides, the device can have a relatively low power consumption because of a relatively high energy transfer efficiency between said communicators during use.

Although the illustrative embodiments of the present invention have been described in greater detail with reference to the accompanying drawing, it is to be understood that the invention is not limited to those embodiments. Various changes or modifications may be effected by one skilled in the art without departing from the scope or the spirit of the invention as defined in the claims.

For instance, the information carrier may comprise one or more integrated circuits. Besides, each integrated circuit may be arranged in different ways. Each of the one or more integrated circuits may provided in the form of a chip or a similar micro-electronics unit. The integrated circuit may be arranged, for instance, for storing data, for performing calculations, for executing program code and/or the like.

Besides, each first communicator may be arranged in various ways. For instance, the first communicator 11 may be arranged for optical, inductive and/or electromagnetic communication or the like. Each first communicator may, for instance, comprise one or more antennas, one or more optical elements, suitable communication means, coupling elements and/or the like. The same holds for each said second communicator. Further, the first communicator may extend at least partly on or, in a first side and/or on or in an opposite second side of a disc 1.

The first communicator may be located in various positions. For instance, at least a communication part of the first communicator may extend at least in the central point of the respective disc. Besides, at least a communication part of the first communicator may be located in a centre area which is enclosed by the annular disc clamping part of the disc.

Furthermore, said information carrier may comprise different types of discs, for instance having standardized CD-, DVD-, dimensions, ‘portable blue’ dimensions and/or other dimensions. The information carrier may comprise one or more information carrying layers. The information carrier may contain, for instance, computer data, audio data, video data and/or other types of information.

The blind hole in the disc may also have various dimensions, for having a bottom area of about 1 mm² or less, or having a larger bottom surface.

Furthermore, the device 50 for recording and/or reproducing information may comprise several means for holding an information carrier, for instance one or more clamping members, a turntable and/or the like.

Besides, the subject-matter of at least claims 1 and 2 may be combined in various ways. For instance, an information carrier according to claim 2 may be provided with an annular clamping part C, to be held by a damper during use. Also, in an information carrier according to claim 2, the first communicator may extend in a centre area which is enclosed by said annular clamping part C. Besides, in an information carrier according to claim 1, the first communicator may also extend at least in the central point of the disc.

Furthermore, the disc rotation axis A may extend centrally through said central disc area and/or through said central disc point.

1. Information carrier, comprising a disc (1; 101; 201; 301; 401) which is provided with at least one data layer (2; 102; 202; 302; 403) for optically reading and/or writing information, wherein the disc comprises an annular clamping part (C), to be held by a damper (121) during use, wherein the disc (1; 101; 201; 301; 401) comprises at least one integrated circuit (3; 103; 203; 303; 403), wherein said integrated circuit (3; 103; 203; 303; 403) comprises a first communicator (4; 104; 204; 304; 404) for communication with at least a second, external, communicator (11; 111; 211; 311; 411) during use, wherein the first communicator (4; 104; 204; 304; 404) extends in a centre area (5, 6; T) which is enclosed by said annular clamping part (C).

2. Information carrier, for instance of the type according to claim 1, comprising a disc (1; 101; 201; 301; 401) which is provided with at least one layer (2; 102; 202; 302; 403) for optically reading and/or writing information, wherein the disc (1; 101; 201; 301; 401) comprises at least one integrated circuit (3; 103; 203; 303; 403), wherein said integrated circuit (3; 103; 203; 303; 403) comprises a first communicator (4; 104; 204; 304; 404) for communication with at least a second, external, communicator (11; 111; 211; 311; 411) during use, wherein the first communicator (4; 104; 204; 304; 404) extends at least in the central point of the disc (1; 101; 201; 301; 401).

3. Information carrier according to claim 1, wherein the first communicator (4; 104; 204; 304; 404) extends in an annular transition part (T) of the disc.

4. Information carrier according to claim 1, wherein said first communicator (4; 104) is part of said integrated circuit (3; 103).

5. Information carrier according to claim 1, wherein said integrated circuit (3; 103) is an unbonded chip.

6. Information carrier according to claim 1, wherein the integrated circuit (3) is located at least in the centre area or central point of the disc (1).

7. Information carrier according to claim 1, wherein the disc (1) is provided with a central bridge part (5), wherein at least said first communicator (4) is located on or in said bridge part (5).

8. Information carrier according to claim 1, wherein said at least one layer (2; 102) for optically reading and/or writing information extends outside the centre area of the disc (1; 101).

9. Information carrier according to claim 1, wherein said first communicator comprises at least an antenna (4; 104) for receiving and/or transmitting electromagnetic signals.

10. Information carrier according to claim 1, wherein said first communicator comprises at least an optical transmitter and/or receiver, for instance a photo diode, for transmitting and/or receiving optical signals.

11. Information carrier according to claim 1, wherein the disc (1) is arranged to be rotated about a virtual rotation axis (A) during use for reading and/or writing said information, wherein said rotation axis extends through the central point of the disc (1).

12. Information carrier according to claim 1, wherein said integrated circuit is located on a first side of the disc (1), for instance on the bottom of a blind hole (6), which blind hole (6) extends in the first side of the disc.

13. A device for recording and/or reproducing information on/from at least one data layer of a rotatable disc, wherein the device (50) comprises at least a second communicator (11; 111; 211; 311; 411) for communicating with at least a first communicator (4; 104; 204; 304; 404) of a disc (1; 101; 201; 301; 401) one according to claim 1.

14. A device according to claim 13, wherein said second communicator (11) is arranged to send and/or transmit data to the centre area and/or the central point of a disc (1; 101) during rotation of the disc by said device (50).

15. A device according to claim 13, wherein said second communicator comprises a coil (11; 111; 211; 311).

16. A device according to claim 13, comprising a damper (21; 121; 221; 321; 421) and/or turntable (22; 122; 222; 322; 422) which is arranged for holding a disc by a clamping part (C) of the disc, wherein preferably said clamping part (C) is an annular disc part.

17. A device according to claim 16, wherein said second communicator is located substantially outside said damper and/or turntable.

18. A device according to claim 16, wherein said second communicator is located substantially within said damper and/or turntable.

19. A device according to claim 15, wherein the outer diameter of said coil (11; 111; 411) is smaller than an inner diameter of the clamping part (C) of said disc.

20. A device according to claim 16, wherein the clamper and/or turntable comprises a central aperture (25), wherein said second communicator (11) is located within said central aperture (25) during use.

21. A device according to claim 13 wherein said integrated circuit is located on a first side of the disc (1), for instance on the bottom of a blind hole (6), which blind hole (6) extends in the first side of the disc, and wherein said second communicator (111) is positioned such, that the second communicator (111) is arranged opposite the first side of the disc (101) during use.

22. A device according to claim 13 wherein said integrated circuit is located on a first side of the disc (1), for instance on the bottom of a blind hole (6), which blind hole (6) extends in the first side of the disc, and wherein said second communicator (211) is positioned such, that the second communicator is arranged opposite a second side of the disc (201) during use, which second disc side aced away from said first disc side.

23. A device according to claim 12, wherein the second communicator comprises a dipole antenna (411).

24. A device according to claim 23, wherein the dipole antenna (411) is substantially circular.

25. A device according to claim 23, wherein the dipole antenna comprises at least two substantially circular, concentric antenna arms (411a, 411b), wherein the antenna arms are (411a, 411b) concentric with the path of a respective disc (401) during use of the device (450) in combination with the disc (401), wherein the antenna arms are dimensioned such, that the radius of the path of a first communicator (404) of the disc (401) is larger than the radius of the inner antenna arm (411b), and smaller than the radius of the outer antenna arm (411a) during use.

26. A method for manufacturing an information carrier, wherein a disc (1) is being injection-moulded such, that the disc (1) comprises no central aperture, wherein a central part of the disc (1) is provided with at least one integrated circuit (3), comprising a first communicator (4) for communication with at least a second, external, communicator (11) during use.

27. A method for manufacturing an information carrier, wherein a disc (1) is being injection-moulded such, that the disc (1) comprises a central aperture, wherein a bridge part is applied to the disc for bridging at least part of the central aperture, the bridge part is being provided with at least one integrated circuit (3), comprising a first communicator (4) for communication with at least a second, external, communicator (11) during use.
